(19) United States
(12) Patent Application Publication
(10) Pub. No.: US 2010/0212275 A1
(43) Pub. Date: Aug. 26, 2010

(54) EXHAUST GAS CLEANING DEVICE AND METHOD FOR MANUFACTURING AN EXHAUST GAS CLEANING DEVICE

(76) Inventors: Stefan Schmidt, Langweld am Lech (DE); Stefan Merschkoetter, Esslingen (DE); Peter Kroner, Zweibruecken (DE)

Correspondence Address: CARLSON, GASKEY & OLDS, P.C., 400 WEST MAPLE ROAD, SUITE 350, BIRMINGHAM, MI, 48009, US

(21) Appl. No.: 12/161,049

(22) PCT Filed: Jan. 11, 2007
(86) PCT No.: PCT/EP2007/000200

§ 371 Date: Apr. 22, 2010

(30) Foreign Application Priority Data
Jan. 19, 2006 (DE) 10 2006 002 688.8

(51) Int. Cl. B01D 46/00; B32B 37/12

(52) U.S. Cl. 55/502; 156/293

(57) ABSTRACT

An exhaust gas cleaning device includes an outer housing, an insert disposed therein, and an elastic compensating element which surrounds the insert. At least before a first operation, an adhesive layer is provided between the insert and the compensating element and/or between the compensating element and the outer housing. Furthermore, there is described a method for manufacturing an exhaust gas cleaning device.

### RELATED APPLICATIONS

The application is the U.S. National Phase of PCT/EP2007/000200 filed 11 Jan. 2007, which claimed priority to German Application 10 2006 002 688.8 filed 19 Jan. 2006.

### BACKGROUND OF THE INVENTION

This invention relates to an exhaust gas cleaning device with an outer housing, an insert disposed therein, and an elastic compensating element which surrounds the insert. Furthermore, this invention relates to a method for manufacturing an exhaust gas cleaning device which includes an outer housing with an insert disposed therein, and an elastic compensating element surrounding the insert.

Exhaust gas cleaning devices in accordance with the invention in particular are catalysts, particulate filters, or combinations thereof. The same usually include an insert in the form of a ceramic substrate, which acts as a mechanical filter (particulate filter) or is coated with a catalytic material for exhaust gas cleaning. The insert is wrapped with an elastic compensating element (usually referred to as bearing mat) and is retained in the outer housing by radial clamping. For this purpose, the elastic compensating element exerts a holding force on the insert, which must be large enough to prevent an axial displacement of the insert relative to the outer housing in driving operation, which can occur for instance as a result of the gas pressure and due to vibrations.

In exhaust gas cleaning devices known from the prior art it is disadvantageous that the necessary holding force exerted on the insert is only achieved when a bearing mat constituting a so-called “swelling mat” expands (or “swells”) in response to an elevated temperature. For this purpose, however, the swelling mat must once be exposed to a temperature of about 300° C. to 350° C. In a vehicle with a novel exhaust gas cleaning device, in particular in a vehicle driven by a Diesel engine, with an exhaust gas cleaning device disposed in the region of the underbody, only temperatures of about 200° C. initially are achieved in normal driving operation in city traffic. Therefore, it is possible that the bearing mat remains in a non-expanded condition for an extended period, for instance up to the first regeneration of a particulate filter, in which the expansion temperature of the mat is then achieved for the first time. Up to this time there is thus a risk that the insert is axially displaced in the housing due to the insufficient holding force. To prevent this, known bearing mats are made very thick, or an additional axial and possibly radial support is effected, e.g. by wire mesh rings. Another possibility involves using non-swelling bearing mats, with which a sufficient holding force is achieved via a larger gap region. However, these non-swelling bearing mats are clearly more expensive than swelling mats.

The object of the invention is to create an exhaust gas cleaning device, in which the insert is safely retained from the start (i.e. also before a high temperature was achieved in the exhaust system), and which has little constructive effort and low manufacturing costs.

### SUMMARY OF THE INVENTION

In an exhaust gas cleaning device as mentioned above, at least before the first operation, an adhesive layer is provided between an insert and a compensating element, and/or between the compensating element and an outer housing. By using the adhesive layer, an adhesion is achieved between the insert and the compensating element (or between the compensating element and the outer housing), and the insert is safely retained in a mounting position already before the expansion of the compensating element. Even in the case of a non-swelling bearing mat such adhesive layer may be expedient, as the adhesive layer contributes to an increase of the holding force at elevated temperatures, at which the outer housing is slightly expanded.

Advantageously, the adhesive layer is formed such that its adhesive properties are maintained at elevated temperatures, in particular at temperatures up to 350° C. As mentioned already, the bearing mat expands at a temperature of about 300° C. to 350° C., whereupon the insert is retained in the outer housing safely enough due to the clamping force exerted by the mat. Before the expansion temperature of the mat is achieved, the adhesive layer prevents a displacement of the insert relative to the outer housing. The adhesive layer can be formed such that it melts or burns at elevated temperatures, when it is no longer required for retaining the insert. Advantageously, the adhesive layer is formed of an adhesive which does not secrete any toxic substances during evaporation or combustion.

In accordance with one example embodiment, the adhesive layer is formed by a double-faced adhesive tape, which has a particularly good processability, a uniform layer thickness, and a short setting time. With an adhesive tape it is also ensured that the adhesive does not penetrate into the bearing mat or the compensating element.

The double-faced adhesive tape can exclusively consist of an adhesive film, i.e. be completely formed without a carrier layer, for instance in the form of a film.

Alternatively, the adhesive layer can also be formed by a liquid adhesive or by a spray adhesive. Again, care should be taken that the adhesive does not penetrate into the compensating element.

The use of an adhesive layer of a thermally activatable adhesive offers a further advantage. It provides for manufacturing the exhaust gas cleaning device by a so-called “stuffing” method, wherein the adhesive layer is applied onto the insert, the elastic compensating element, and/or the outer housing, with the insert and the surrounding compensating element being stuffed into the outer housing. The adhesive will be activated only after stuffing, in particular only during the first operation of the vehicle. In this case, however, the activation temperature of the adhesive should lie distinctly below the temperatures achieved during the first start of the vehicle.

In principle, any kind of adhesive can be used, and the adhesive layer can for instance be formed by a rubber-based adhesive or by an acrylate-based adhesive.

In accordance with a second aspect of the invention, a method for manufacturing an exhaust gas cleaning device is provided, which comprises the following steps: The insert, the elastic compensating element, and the outer housing or a sheet metal forming the outer housing are provided. Subsequently, an outer surface of the insert, and/or an inner surface of the compensating element, and/or an outer surface of the compensating element, and/or an inner surface of the outer housing or of the sheet metal are provided with an adhesive layer. Finally, the insert and the compensating element are mounted in the outer housing. By the method of the invention, an exhaust gas cleaning device is created in which the insert is safely retained in the outer housing at any time, i.e. from the time of manufacture.

These and other features of the present invention can be best understood from the following specification and drawings, the following of which is a brief description.

### BRIEF DESCRIPTION OF THE DRAWINGS

FIG. 1 shows a longitudinal section through an exhaust gas cleaning device in accordance with a first embodiment of the invention.

FIG. 2 shows an enlarged detailed view from FIG. 1.

FIG. 3 shows a detailed view similar to FIG. 2, but of an exhaust gas cleaning device in accordance with a second embodiment of the invention.

FIG. 4 shows a schematic representation of the method of the invention for manufacturing an exhaust gas cleaning device.

### DETAILED DESCRIPTION OF THE PREFERRED EMBODIMENT

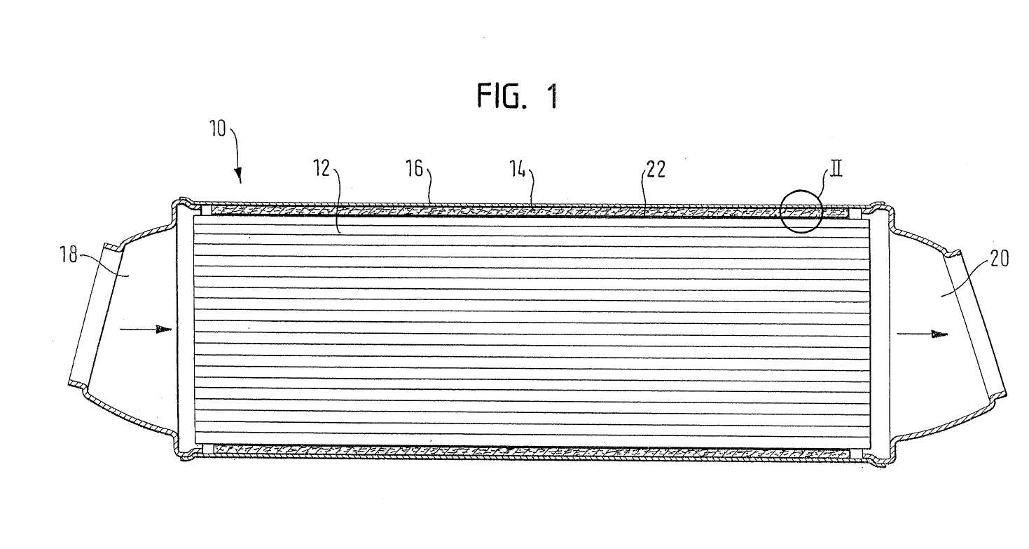

FIG. 1 shows an exhaust gas cleaning device 10 for an exhaust system of a motor vehicle. The exhaust gas cleaning device 10 is a particulate filter, an exhaust gas catalyst, or a combination thereof.

A central part of the exhaust gas cleaning device 10 is an insert 12, for example an elongated cylindrical substrate, which consists for instance of a ceramic substrate, a wound corrugated board, or some other catalytic carrier or filter material with or without coating. The insert 12 can have a circular cylindrical or non-circular cross-section. A circular cylindrical cross-section is only shown for simplified representation.

The substrate is surrounded by a bearing mat, which acts as an elastic compensating element 14 between the insert 12 and an outer housing 16. The outer housing 16 in particular is made of sheet metal and is very thin-walled. Upstream and downstream, an inlet funnel 18 and an outlet funnel 20 are respectively connected with the outer housing 16.

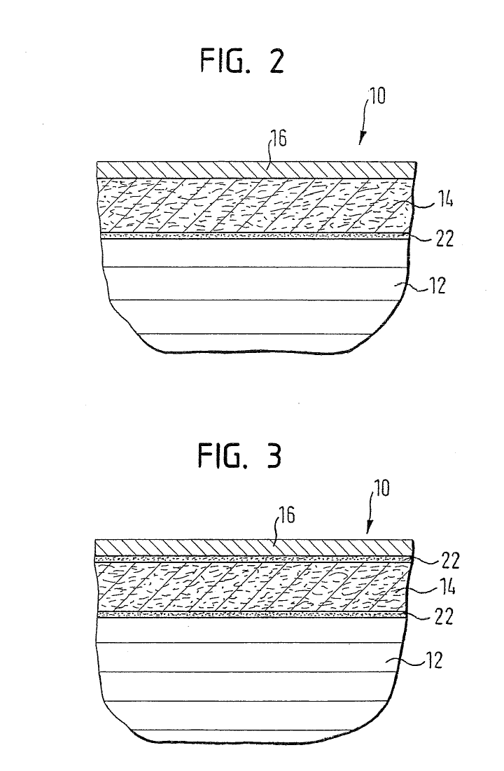

Between the insert 12 and the compensating element 14, an adhesive layer 22 is provided (see also FIG. 2). The same can be formed for instance by a double-faced adhesive tape, a liquid adhesive, or a spray adhesive and prevents a displacement of the insert 12 relative to the compensating element 14 (or to the outer housing 16).

FIGS. 1 and 2 show the exhaust gas cleaning device 10 in the condition before the first operation. In driving operation, exhaust gas flows through the inlet funnel 18 on an end face into the insert 12 and leaves the same with less noxious substances on an opposite end face, in order to leave the exhaust gas cleaning device 10 through the outlet funnel 20. When the exhaust gas cleaning device 10 reaches a temperature of more than 350° C. in operation of the vehicle, for instance during a regeneration of the particulate filter, the adhesive layer 22 is thermally destroyed, for instance by melting, evaporation or combustion. Since at this time, however, the compensating element 14 is already expanded, a reliable retention of the insert 12 in the outer housing 16 is still ensured.

FIG. 3 shows an exhaust gas cleaning device in accordance with a second embodiment of the invention, which merely differs from that of FIGS. 1 and 2 in that between the compensating element 14 and the outer housing 16 a further adhesive layer 22 is provided in addition. The same prevents slipping of the compensating element 14 relative to the outer housing 16. Of course, an adhesive layer 22 might also be provided only between the compensating element 14 and the outer housing 16.

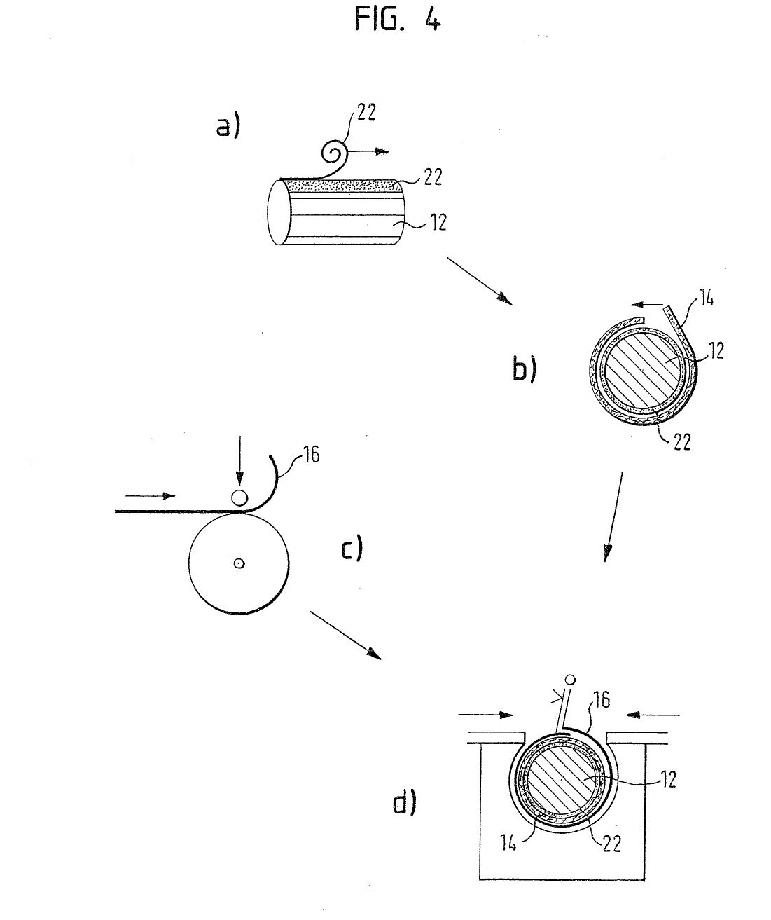

Subsequently, the manufacture of the exhaust gas cleaning device will briefly be explained with reference to FIG. 4. First, the insert 12 is provided with an adhesive layer 22 on its outer surface (FIG. 4a), before the compensating element 14 (the bearing mat) is wound about the insert 12 (FIG. 4b). Subsequently, the outer housing 16, which was prefabricated from a sheet metal for instance by mandrel bending or roller bending (FIG. 4c), is slightly spread and the insert 12 is laterally pushed into the outer housing 16 together with the compensating element 14. The outer housing 16 is closed, in that the overlapping edges of the outer housing are pushed over each other and welded to each other (FIG. 4d).

Beside the winding method described above, any other known method for manufacturing an exhaust gas cleaning device can be modified correspondingly. For instance, mounting the insert and the compensating element in the outer housing can be effected by what is called sizing, wherein a plurality of radially movable clamping jaws plastically deform a prefabricated tubular outer housing. In addition, sizing by means of rollers or so-called “spinning” also is possible. The outer housing also can consist of two or more shells, which are pushed into each other and subsequently welded to each other, seamed or soldered. Stuffing the insert along with the compensating element into a prefabricated tubular outer housing also is conceivable.

Although an embodiment of this invention has been disclosed, a worker of ordinary skill in this art would recognize that certain modifications would come within the scope of this invention. For that reason, the following claims should be studied to determine the true scope and content of this invention.

1. An exhaust gas cleaning device comprising:
an outer housing;
an insert disposed in the outer housing;
an elastic compensating element that surrounds the insert; and
an adhesive layer provided between at least one of the insert and the elastic compensating element or the elastic compensating element and the outer housing.

2. The exhaust gas cleaning device according to claim 1, wherein the adhesive layer is formed such that associated adhesive properties are maintained at elevated temperatures up to at least 350° C.

3. The exhaust gas cleaning device according to claim 1, wherein the adhesive layer is formed by a double-faced adhesive tape.

4. The exhaust gas cleaning device according to claim 3, wherein the double-faced adhesive tape is exclusively made of adhesive film.

5. The exhaust gas cleaning device according to claim 1, wherein the adhesive layer is formed by a liquid adhesive.

6. The exhaust gas cleaning device according to claim 1, wherein the adhesive layer is formed by a spray adhesive.

7. The exhaust gas cleaning device according to claim 1, wherein the adhesive layer is formed by a thermally activatable adhesive.

8. The exhaust gas cleaning device according to claim 1, wherein the adhesive layer is formed by a rubber-based adhesive.

9. The exhaust gas cleaning device according to any of claim 1, wherein the adhesive layer is formed by an acrylate-based adhesive.

10. The exhaust gas cleaning device according to claim 1, wherein the adhesive layer is formed of an adhesive that does not secrete any toxic substances during evaporation or combustion.

11. A method for manufacturing an exhaust gas cleaning device, which includes an outer housing with an insert disposed therein and an elastic compensating element surrounding the insert, wherein the method comprises the following steps:
providing the insert, the elastic compensating element, and the outer housing or a sheet metal forming the outer housing;
providing at least one of an outer surface of the insert, an inner surface of the elastic compensating element, an outer surface of the elastic compensating element, or an inner surface of the outer housing or the sheet metal with an adhesive layer; and
mounting the insert and the elastic compensating element in the outer housing.

12. The method according to claim 11 including providing the adhesive layer on more than at least one of the outer surface of the insert, the inner surface of the elastic compensating element, the outer surface of the elastic compensating element, and the inner surface of the outer housing or sheet metal.

13. The exhaust gas cleaning device according to claim 1, wherein the adhesive layer is provided only between the insert and the elastic compensating element.

14. The exhaust gas cleaning device according to claim 1, wherein the adhesive layer is provided only between elastic compensating element and the outer housing.

15. The exhaust gas cleaning device according to claim 1, wherein the adhesive layer is provided between the insert and the elastic compensating element, and wherein the adhesive layer is provided between the elastic compensating element and the outer housing.
